(19) United States
(12) Patent Application Publication
(10) Pub. No.: US 2020/0189517 A1
(43) Pub. Date: Jun. 18, 2020

(54) MOVING DEVICE

(71) Applicant: KABUSHIKI KAISHA TOKAI-RIKA-DENKI-SEISAKUSHO, Aichi (JP)

(72) Inventor: Makoto MATSUZAKI, Aichi (JP)

(21) Appl. No.: 16/323,296

(22) PCT Filed: Aug. 15, 2017
(86) PCT No.: PCT/JP2017/029394

§ 371 Date: Feb. 5, 2019

(30) Foreign Application Priority Data
Aug. 29, 2016 (JP) 2016-167222

(51) Int. Cl. B60R 22/26; B60R 22/20

(52) U.S. Cl. CPC B60R 22/26; B60R 22/03; B60R 22/20

(57) ABSTRACT

In a lift-up buckle device, a movement resistance adjustment portion is provided on an outer circumferential surface of a drive screw. The movement resistance adjustment portion is formed by a first screw segment, a second screw segment, and a third screw segment on which are formed male screw threads that each have mutually different thread precisions. Because of this, when, as a result of the drive screw being rotated, a slider is moved in the longitudinal direction of the drive screw, the ease with which the drive screw can be rotated changes in accordance with the respective thread precisions of the first screw segment, the second screw segment, and the third screw segment.

### TECHNICAL FIELD

The present disclosure relates to a moving device in which a moving body is moved.

### BACKGROUND ART

In a buckle moving device described in Japanese Patent Application Laid-Open (JP-A) No. 2012-131360, an anchor slider is moved while being guided by a rail.

Furthermore, a screw bracket interferes via a damper with the anchor slider, so that the screw bracket causes movement of the anchor slider to stop. As a result, movement of the buckle that operates in conjunction with the anchor slider is also stopped.

Here, in this type of a buckle moving device, it is preferable that the speed of movement of the buckle be changed such that the speed of movement of the buckle when, for example, the buckle starts moving or stops moving is slower in comparison with times other than these.

### SUMMARY OF THE INVENTION

### Technical Problem

In consideration of the above-described circumstances it is an object of the present disclosure to provide a moving device that enables the speed of movement of a moving body to be changed.

### Solution to the Problem

A moving device of a first aspect of the present disclosure is provided with a moving body that is provided in a seatbelt device and is moved, and with a movement resistance adjustment portion that is provided on a movement path of the moving body and changes a movement resistance of the moving body.

A moving device of a second aspect of the present disclosure is characterized in that, in the moving device of the first aspect, a driving component is screwed together with the moving body and, by rotating, causes the moving body to move in a longitudinal direction, wherein the movement resistance adjustment portion is provided in the driving component and, in conjunction with the movement of the moving body, changes the movement resistance of the moving body towards the driving component.

A moving device of a third aspect of the present disclosure is characterized in that, in the moving device of the first or second aspects, further comprising a contacting body along which the moving body is moved relatively, wherein the movement resistance adjustment portion is provided in the contacting body, and changes a state of contact between the moving body and the contacting body in conjunction with the movement of the moving body.

A moving device of a fourth aspect of the present disclosure is characterized in that, in the moving device of the third aspect, a protruding portion is provided on the moving body, and protrudes onto the contacting body side.

A moving device of a fifth aspect of the present disclosure is characterized in that, in the moving device of any one of the first through fourth aspects, the movement resistance adjustment portion protrudes onto the movement path side of the moving body, and absorbs kinetic energy from the moving body when struck by the moving body.

### Advantageous Effects of the Invention

In the moving device of the first aspect of the present disclosure, a moving body is provided in a seatbelt device, and this moving body is moved.

Here, in the moving device there is provided a movement resistance adjustment portion, and this movement resistance adjustment portion is provided on a movement path of the moving body, and changes the movement resistance of the moving body. Because of this, it is possible to change the speed of movement of the moving body.

In the moving device of the second aspect of the present disclosure, a circular-column shaped driving component is provided in the seatbelt device, and this driving component causes the moving body to move in the longitudinal direction of the driving component.

Here, in the driving component there is provided a movement resistance adjustment portion, and this movement resistance adjustment portion changes the movement resistance of the moving body towards the driving component in conjunction with the movement of the moving body. Because of this, it is possible to change the speed of movement of the moving body.

In the moving device of the third aspect of the present disclosure, there is provided a contacting body, and the moving body is made to move relatively to the contacting body.

Here, in the contacting body there is provided a movement resistance adjustment portion, and this movement resistance adjustment portion changes the state of contact between the moving body and the contacting body in conjunction with the movement of the moving body. As a result of this, because the movement resistance of the moving body is changed, it is possible to change the speed of movement of the moving body.

In the moving device of the fourth aspect of the present disclosure, a protruding portion is provided on the moving body, and this protruding portion protrudes onto the contacting body side. Accordingly, the movement resistance adjustment portion is able to easily change the state of contact between the protruding portion and the contacting body in conjunction with the movement of the moving body

In the moving device of the fifth aspect of the present disclosure, the movement resistance adjustment portion protrudes onto the movement path side of the moving body.

Here, the movement resistance adjustment portion absorbs kinetic energy from the moving body when struck by the moving body. As a consequence, because the movement resistance of the moving body changes, it is possible to change the speed of movement of the moving body.

### BRIEF DESCRIPTION OF THE DRAWINGS

FIG. 1 is an exploded perspective view as seen from a front-left side diagonal direction showing a lift-up buckle device according to a first exemplary embodiment of the present disclosure.

FIG. 2 is a cross-sectional view as seen from the left side showing the lift-up buckle device according to the first exemplary embodiment of the present disclosure.

FIG. 3 is a side view as seen from the left side showing a drive screw of the lift-up buckle device according to the first exemplary embodiment of the present disclosure.

FIG. 4A is a side view as seen from the left side showing principal portions of a lift-up buckle device according to a second exemplary embodiment of the present disclosure.

FIG. 4B is a cross-sectional view showing a state across a line A-A in FIG. 4A.

FIG. 5 is a lower surface view as seen from underneath showing principal portions of a lift-up buckle device according to a third exemplary embodiment of the present disclosure.

FIG. 6 is a cross-sectional view as seen from the left side showing a lift-up buckle device according to a fourth exemplary embodiment of the present disclosure.

### DESCRIPTION OF THE EMBODIMENTS

### First Exemplary Embodiment

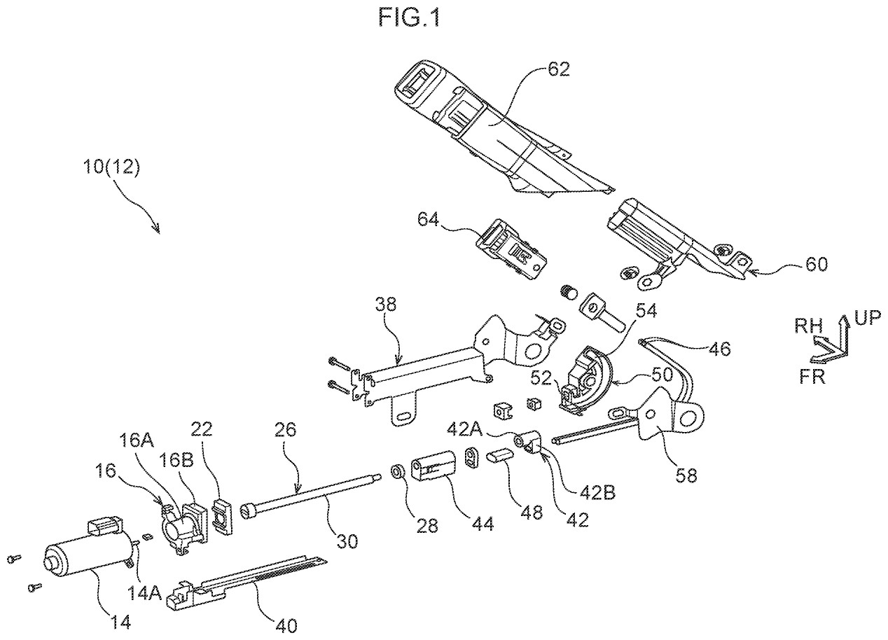

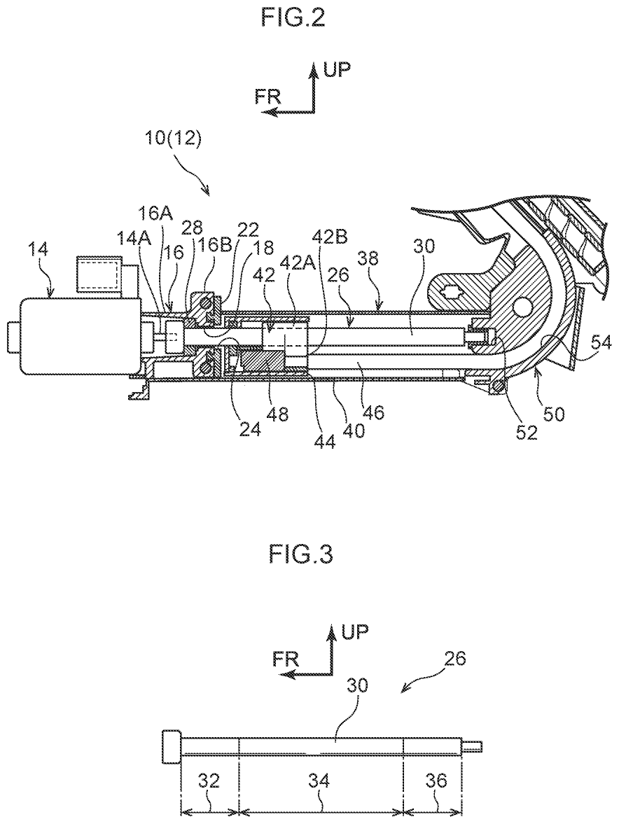

In FIG. 1, a lift-up buckle device 10 that is serving as a moving device according to a first exemplary embodiment of the present disclosure is shown in an exploded perspective view as seen from a front-left side diagonal direction. In FIG. 2, the lift-up buckle device 10 is shown in a cross-sectional view as seen from the left side. Note that, in the drawings, a front side of the lift-up buckle device 10 is shown by an arrow FR, a right side of the lift-up buckle device 10 is shown by an arrow RH, and an upward side of the lift-up buckle device 10 is shown by an arrow UP.

The lift-up buckle device 10 according to the present exemplary embodiment forms part of a seatbelt device 12 of a vehicle (i.e., an automobile), and this seatbelt device 12 is used on a seat (not shown in the drawings) inside a vehicle cabin. A seating sensor (not shown in the drawings) is provided in the seat, and this seating sensor detects when a vehicle occupant is sitting in the seat, and is also electrically connected to a control device (not shown in the drawings).

The seatbelt device 12 is provided with a take-up device (not shown in the drawings), and this take-up device is fixed to a lower side and an outer side in a vehicle width direction of a seat rear portion. An elongated belt-shaped webbing (i.e., a seat belt: not shown in the drawings) is taken up by the take-up device from a base end side thereof, and this webbing is pulled out from the take-up device. A distal end side from the take-up device of the webbing is movably inserted through a through anchor (not shown in the drawings), and this through anchor is supported on an upper side and the outer side in the vehicle width direction of the seat rear portion. A distal end of the webbing is fixed to an anchor (not shown in the drawings), and this anchor is fixed to the lower side and the outer side in the vehicle width direction of the seat rear portion. The webbing is also movably inserted through a tongue (not shown in the drawings) between the through anchor and the anchor.

The lift-up buckle device 10 is fixed to the lower side and an inner side in the vehicle width direction of the seat, and a front side, a right side, and an upper side of the lift-up buckle device 10 face respectively towards the front side, the right side, and the upper side of the vehicle.

As is shown in FIG. 1 and FIG. 2, a motor 14 is provided in a front end portion of the lift-up buckle device 10, and an output shaft 14A of the motor 14 protrudes towards the rear. The motor 14 is electrically connected to the aforementioned control device, and as a result of the motor being driven normally or in reverse through the control of the control device, the output shaft 14A is rotated in one direction or in another direction respectively.

A metal housing 16 is disposed on a rear side of the motor 14, and the motor 14 is attached to the housing 16. A circular-cylinder shaped supporting tube 16A is provided in a front-side portion of the housing 16, and the output shaft 14A of the motor 14 is inserted inside the supporting tube 16A so as to be coaxial therewith.

As is shown in FIG. 2, a substantially rectangular-parallelepiped shaped stopping block 16B that is serving as a stopping body is provided on a rear end portion of the housing 16, and a circular through hole 18 is formed penetrating a central portion of the stopping block 16B. The through hole 18 communicates with the interior of the supporting tube 16A so as to be coaxial therewith, and a radial dimension of the through hole 18 is slightly smaller in comparison with a radial dimension of the interior of the supporting tube 16A.

A substantially rectangular-plate shaped damper 22 that is serving as an absorption body is attached to a rear side of the housing 16. The damper 22 is made of rubber, and has elasticity. A circular through hole 24 is formed penetrating a central portion of the damper 22, and the through hole 24 communicates with the through hole 18 in the stopping block 16B so as to be coaxial therewith.

A substantially circular-column shaped drive screw 26 that is made from metal and serves as a driving component is inserted inside the supporting tube 16A of the housing 16, the through hole 18, and the through hole 24 of the damper 22 so as to be coaxial with these, and this drive screw 26 protrudes from a rear side of the damper 22. The vicinity of a front end of the drive screw 26 is rotatably fitted inside a circular-cylinder shaped bearing 28, and this bearing 28 is fixed inside the supporting tube 16A. The output shaft 14A of the motor 14 is connected to the front end of the drive screw 26, so that the drive screw 26 is rotated integrally with the output shaft 14A.

As is shown in FIG. 3, a movement resistance adjustment portion 30 is provided on an outer circumference of the drive screw 26 except for a front end portion and a rear end portion thereof. This movement resistance adjustment portion 30 is formed by a first screw segment 32 that is located on the front side, a second screw segment 34 that is adjacent to a rear side of the first screw segment 32, and a third screw segment 36 that is adjacent to a rear side of the second screw segment 34. Male screw threads that each have the same pitch are formed on the respective outer circumferences of the first screw segment 32, the second screw segment 34, and the third screw segment 36. The thread precision (as an example, the tolerance of the outer diameter and effective diameter of the screw thread relative to a reference screw thread profile) of the male screw thread of the first screw segment 32 is set lower (i.e. has a larger tolerance) than the thread precision of the male screw threads of each of the second screw segment 34 and the third screw segment 36. In addition, the thread precision of the male screw thread of the second screw segment 34 is set higher (i.e. has a smaller tolerance) than the thread precision of the male screw thread of the third screw segment 36. In other words, the screw grades of each of the first screw segment 32, the second screw segment 34, and the third screw segment 36 are all mutually different.

As is shown in FIG. 1, a metal rail 38 that is serving as a contacting body is attached to the rear side of the housing 16. The rail 38 is formed in an elongated-plate shape having a substantially U-shaped cross-section whose interior is open towards the downward side. A left wall and a right wall of the rail 38 are joined to each other via a top wall. The drive screw 26 is housed inside the rail 38, and the rail 38 is disposed so as to be parallel with the drive screw 26. The damper 22 is disposed between the upper wall of the rail 38 and a rear surface of the stopping block 16B of the housing 16.

An elongated, substantially rectangular-plate shaped rail cover 40 that is formed from resin and serves as an additional component is fixed to the lower side of the rail 38. This rail cover 40 covers the interior of the rail 38 from the downward side.

A metal slider 42 that serves as a moving component which forms part of a moving body is disposed inside the rail 38, and a substantially circular-cylinder shaped engaging portion 42A is provided on an upper-side portion of the slider 42. A female thread is formed on an inner circumferential surface of the engaging portion 42A. The drive screw 26 is inserted inside the engaging portion 42A so as to be coaxial therewith, and the female thread of the engaging portion 42A is screwed onto the male thread on the drive screw 26. A substantially rectangular-parallelepiped shaped fixing portion 42B is provided integrally with a rear-side portion of the engaging portion 42A, and the fixing portion 42B protrudes on the downward side from the engaging portion 42A.

A resin shoe 44 that serves as a peripheral component which forms part of the moving body is provided around a periphery of the slider 42. An interior of the shoe 44 is open towards the rear side, and the engaging portion 42A and fixing portion 42B of the slider 42 are housed inside the shoe 44.

A left wall and a right wall of the shoe 44 are in contact respectively with the left wall and right wall of the rail 38. As a result, movement of the shoe 44 in the left-right direction is restricted, and rotation around the drive screw 26 of the shoe 44 and slider 42 relative to the rail 38 is also restricted. Consequently, when the drive screw 26 is rotated, the shoe 44 and the slider 42 are moved integrally with each other in the front-rear direction while being guided by the rail 38.

Base end portions (i.e., front-side end portions) of a pair of wires 46 that are serving as connecting components which form part of the moving body penetrate the fixing portion 42B of the slider 42. The base end portions of the pair of wires 46 are fixed to the fixing portion 42B via crimping or the like, and are consequently able to move integrally with the slider 42. A component 48 is fixed on the front side of the fixing portion 42B to the pair of wires 46, and this component 48 is housed inside the shoe 44.

A metal, block-shaped wire guide 50 that serves as a guiding component is fixed to a rear end of the rail 38, so that the wire guide 50 has a substantially fan-shaped configuration when looked at in a side view. A shaft support hole 52 is formed in a front end of a lower portion of the wire guide 50, and a rear end portion of the drive screw 26 is rotatably supported in the shaft support hole 52. A guide groove 54 is formed in the wire guide 50, so that the guide groove 54 is open on the left side thereof. The guide groove 54 has a curved shape when looked at in a side view, and a lower end portion of the guide groove 54 is open on the front side thereof, while an upper end portion of the guide groove 54 gradually opens up in a front-side facing direction as it approaches the upper side. The pair of wires 46 are inserted through the guide groove 54, and a portion on the base end side from the wire guide 50 of the pair of wires 46 extends in the front-rear direction, while a portion on the distal end side from the wire guide 50 of the pair of wires 46 gradually protrudes in a forwards-facing direction as it approaches the upper side. A metal, plate-shaped cover plate 58 is fixed to a left side of the wire guide 50, and this cover plate 58 closes off the left side of the guide groove 54.

A base end portion of a cylindrical lower cover 60 that is formed, for example, from rubber and serves as a supporting body is attached to an upper portion of the wire guide 50, and this lower cover 60 gradually extends in a forwards-facing direction as it approaches the upper side. An interior of the lower cover 60 communicates with an upper end portion of the guide groove 54 of the wire guide 50, and the pair of wires 46 are inserted through the interior of the lower cover 60.

A distal end side (i.e., an upper-front side) of the lower cover 60 is inserted inside a cylindrical buckle cover 62 that is formed, for example, from resin and serves as a protective material which forms part of the moving body, and this buckle cover 62 is more rigid in comparison to the lower cover 60. The buckle cover 62 is able to slide over the lower cover 60, and the pair of wires 46 are inserted inside the buckle cover 62.

A buckle 64 that is serving as a connecting component which forms part of the moving body is fixed to the interior of the buckle cover 62, and the distal end portion (i.e., the rear-side end portion) of the pair of wires 46 is connected to the buckle 64. The buckle cover 62 exposes a distal end side (i.e., an upper-front side) of the buckle 64, and the aforementioned tongue can be removably fitted into the buckle 64. A buckle switch (not shown in the drawings) is provided in the buckle 64, and this buckle switch detects whether or not the tongue has been fitted into the buckle 64, and is also electrically connected to the aforementioned control device.

### Action and Effects of the First Exemplary Embodiment

Next, an action of the present exemplary embodiment will be described.

In the lift-up buckle device 10 that has the above-described structure, when no vehicle occupant is sitting in the seat (i.e., when it has not been detected by the seating sensor that a vehicle occupant is sitting in the seat), the slider 42 and the shoe 44 are disposed in front of the drive screw 26 and the rail 38, and the buckle cover 62 and the buckle 64 are disposed in a lower-rear side storage position.

When a vehicle occupant is sitting in the seat (i.e., when it has been detected by the seating sensor that a vehicle occupant is sitting in the seat), the motor 14 is driven normally via the control of the control device so that the output shaft 14A and the drive screw 26 are rotated in the one direction. As a result, the slider 42 and the shoe 44 are moved towards the rear side while being guided by the rail 38 of the rail 38. Because of this, the pair of wires 46 are moved towards the distal end side integrally with the slider 42 so that, as a result, the buckle cover 62 and the buckle 64 are moved towards the upper-front side and are placed in a raised position. In addition, webbing is pulled out from the take-up device and the tongue of the webbing is fitted into the buckle 64. Moreover, because the tongue has been fitted into the buckle 64 that has been placed in the raised position, the insertion of the tongue in the buckle 64 can be performed easily.

Once the tongue has been fitted into the buckle 64 (i.e., when the buckle switch has detected that the tongue has been fitted into the buckle 64), the motor 14 is driven in reverse via the control of the control device so that the output shaft 14A and the drive screw 26 are rotated in the other direction. As a result, the slider 42 and the shoe 44 are moved towards the front side while being guided by the rail 38 of the rail 38. Because of this, the pair of wires 46 are moved towards the base end side integrally with the slider 42 so that, as a result, the buckle cover 62 and the buckle 64 are moved towards the lower-rear side and are placed in the storage position. As a result of the tongue together with the buckle 64 being moved via this operation towards the lower-rear side, the webbing is fitted over the user.

Here, the movement resistance adjustment portion 30 is provided on the outer circumferential surface of the drive screw 26, and the movement resistance adjustment portion 30 is formed by the first screw segment 32, the second screw segment 34, and the third screw segment 36 (see FIG. 2) whose respective male screw threads are each formed having mutually different thread precisions (i.e., screw grades). Because of this, when, as a result of the drive screw 26 being rotated, the slider 42 is moved in the longitudinal direction of the drive screw 26, the ease with which the drive screw 26 can be rotated changes in accordance with the respective thread precisions of the first screw segment 32, the second screw segment 34, and the third screw segment 36. Generally, in a screw segment having a lower thread precision, portions of the male screw thread that come into contact with the female screw thread are more tilted than in a screw segment having a higher thread precision so that stress becomes concentrated more easily in these contact portions. Accordingly, the drive screw 26 becomes difficult to rotate, and there is a reduction in the speed of movement of the slider 42 relative to the drive screw 26. In the present exemplary embodiment, because the thread precision of the male screw thread of the first screw segment 32 is lower than the thread precisions of the male screw threads of the second screw segment 34 and the third screw segment 36, when the slider 42 is positioned in the first screw segment 32, the speed of movement of the slider 42 and, therefore, also of the buckle cover 62 and the buckle 64 is reduced. Because the first screw segment 32 corresponds to the movement starting position when the buckle cover 62 and the buckle 64 are being raised up and to the movement end position when these are being lowered, the speed of movement when the movement to raise up the buckle cover 62 and the buckle 64 is started, and the speed of movement when the movement to lower these is ended can both be slowed down.

In addition, the thread precision of the male screw thread of the third screw segment 36 is lower than the thread precision of the male screw thread of the second screw segment 34. Because the third screw segment 36 corresponds to the movement end position when the buckle cover 62 and the buckle 64 are being raised up and to the movement starting position when these are being lowered, the speed of movement when the movement to raise up the buckle cover 62 and the buckle 64 is ended, and the speed of movement when the movement to lower these is started can both be slowed down. In other words, using a simple structure that does not require any control of the revolution speed of the motor 14, it is possible to slow down the respective speeds of movement when the buckle cover 62 and the buckle 64 both start their movement and end their movement, and thus provide a vehicle occupant with a high-quality buckle cover 62 and buckle 64 operation.

Note that in the present exemplary embodiment, a structure is employed in which the first screw segment 32 and the second screw segment 34 are placed mutually adjacent to each other, and the second screw segment 34 and the third screw segment 36 are also placed mutually adjacent to each other, however, the present disclosure is not limited to this, and it is also possible to gradually change the thread precisions in both the first screw segment 32 and the third screw segment 36 as they move further away from the second screw segment 34. Alternatively, it is also possible to provide gradual change segments in which the thread precision gradually changes between the first screw segment 32 and the second screw segment 34 and between the second screw segment 34 and the third screw segment 36 respectively, or to gradually change the thread precision over the full range from the first screw segment 32 to the third screw segment 36.

### Second Exemplary Embodiment

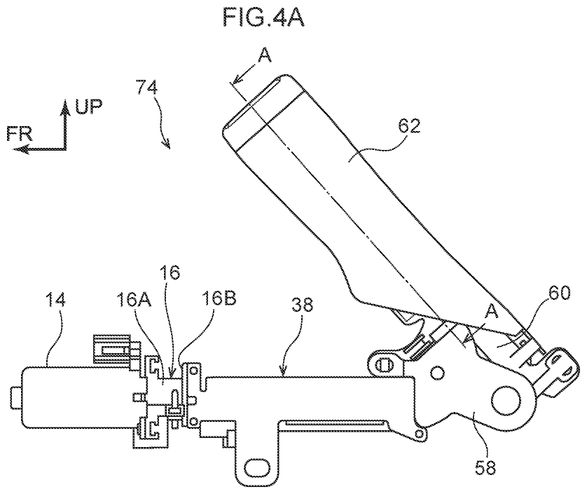

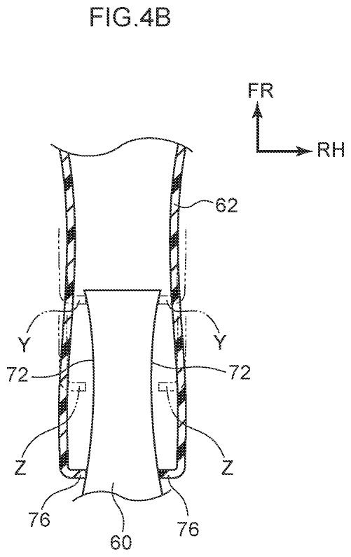

Next, a lift-up buckle device 74 according to a second exemplary embodiment of the present disclosure will be described using FIG. 4A and FIG. 4B. Note that component elements that are basically the same as in the above-described first exemplary embodiment are given the same descriptive symbols and a description thereof is omitted.

As is shown in FIG. 4B, a distal end side (i.e., an upper-front side) of the lower cover 60 that is serving as a contacting body is provided with a pair of left and right contact-receiving surfaces 72 that are serving as movement resistance adjustment portions. The contact-receiving portions 72 are curved such that the pair of contact-receiving portions 72 approach each other as they come closer to a central portion from both end portions thereof within the range of movement of the base end of the buckle 64. A pair of left and right protruding portions 76 are formed at the base end of the buckle cover 62, and the protruding portions 72 protrude towards the lower cover 60 side. When the buckle cover 62 is moved, the protruding portions 76 come into contact with a distal end side (i.e., a front-end side) and a base end side (i.e., a rear-end side) of the contact-receiving surface 72, and are separated from a substantially central portion in the longitudinal direction of the lower cover 60 in the contact-receiving surface 72.

Note that a male screw thread is formed on an outer circumference of the drive screw 26 (see FIG. 2) except for a front end portion and a rear end portion thereof, and the entire male screw thread is formed at the same thread precision.

Here, the same type of effects as those achieved in the first exemplary embodiment are also obtained from the above-described structure.

In other words, because the protruding portions 76 come into contact with the contact-receiving surface 72 at the movement starting position when the buckle cover 62 is being raised and the movement end position when the buckle cover 62 is being lowered (shown by a solid line in the drawings), the movement resistance of the buckle cover 62 is comparatively greater in these positions. As a result, the speed of movement when the movement to raise up the buckle cover 62 is started, and the speed of movement when the movement to lower the buckle cover 62 is ended can both be slowed down.

Moreover, because the movement resistance of the buckle cover 62 is comparatively less in the central portion of the range of movement of the buckle cover 62 due to the protruding portions 76 being separated from the contact-receiving surface 72 in this portion (see a double-dot chain line Z in the drawings), the speed of movement of the buckle cover 62 can be speeded up compared to the speed of movement when the movement to raise up the buckle cover 62 is started, and the speed of movement when the movement to lower the buckle cover 62 is ended.

Furthermore, because the protruding portions 76 come into contact with the contact-receiving surface 72 at the distal end side of the range of movement of the buckle cover 62 (see a double-dot chain line Yin the drawings), the movement resistance of the buckle cover 62 is comparatively greater in these positions, and the speed of movement when the movement to raise up the buckle cover 62 is ended, and also the speed of movement when the movement to lower the buckle cover 62 is started can both be slowed down.

Because the contact-receiving surface 72 is curved, the coming into contact of the protruding portions 76 with the contact-receiving surface 72, as well as the separation of the protruding portions 76 from the contact-receiving surface 72 both proceed gradually. In other words, the speed of movement of the buckle cover 62 changes gradually. As a consequence, using a simple structure that does not require any control of the revolution speed of the motor 14, it is possible to slow down the respective speeds of movement when the buckle cover 62 and the buckle 64 both start their movement and end their movement, and thus provide a vehicle occupant with a high-quality buckle cover 62 and buckle 64 operation.

### Third Exemplary Embodiment

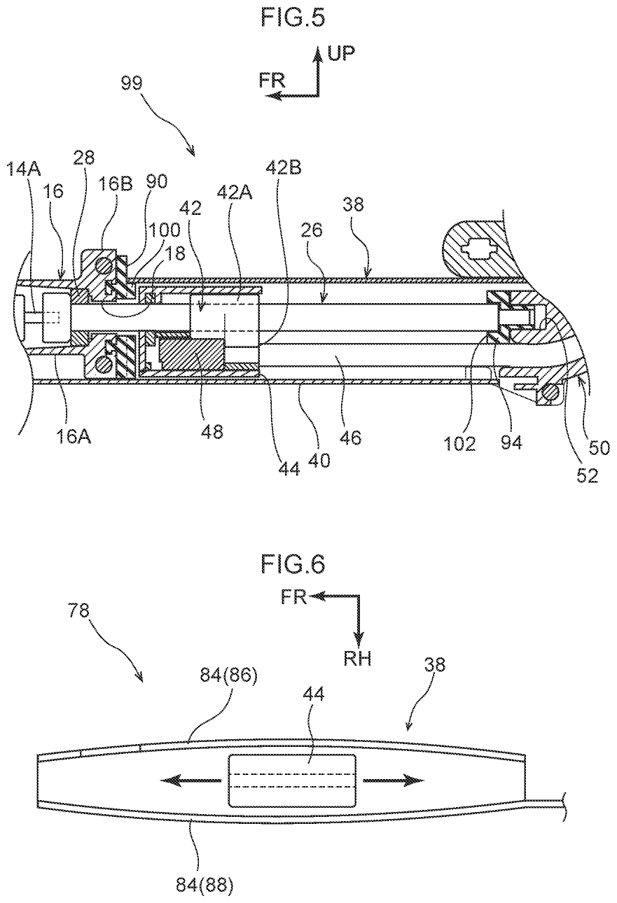

Next, a lift-up buckle device 78 according to a third exemplary embodiment of the present disclosure will be described using FIG. 5. Note that component elements that are basically the same as in the above-described first exemplary embodiment are given the same descriptive symbols and a description thereof is omitted.

Movement resistance adjustment portions 84 are provided on a left wall 86 and a right wall 88 of the rail 38. The left wall 86 and the right wall 88 are curved so as to move away from each other as they approach a substantially central portion in the longitudinal direction thereof from both longitudinal direction end portions thereof, with the result that the left wall 86 and the right wall 88 are both separated from side surfaces of the shoe 44 between a substantially central portion in the longitudinal direction of the left wall 86 and a substantially central portion in the longitudinal direction of the right wall 88. In contrast, the side surfaces of the shoe 44 interfere respectively with the left wall 86 and the right wall 88 between a front end portion of the left wall 86 and a front end portion of the right wall 88. In the same way, the side surfaces of the shoe 44 interfere respectively with the left wall 86 and the right wall 88 between a rear end portion of the left wall 86 and a rear end portion of the right wall 88.

Note that a male screw thread is formed on an outer circumference of the drive screw 26 (see FIG. 2) except for a front end portion and a rear end portion thereof, and the entire male screw thread is formed at the same thread precision.

Here, the same type of effects as those achieved in the first exemplary embodiment are also obtained from the above-described structure.

In other words, because the shoe 44 is positioned between the front end portion of the left wall 86 and the front end portion of the right wall 88 at the movement starting position when the shoe 44 and the buckle cover 62 which is connected to the shoe 44 are being raised and the movement end position when the shoe 44 and the buckle cover 62 which is connected to the shoe 44 are being lowered, the side surfaces of the shoe 44 interfere respectively with the left wall 86 and the right wall 88. Accordingly, because the movement resistance of the shoe 44 is comparatively greater in these positions, the speed of movement when the movement to raise up the shoe 44 and, therefore, also the buckle cover 62 is started, and the speed of movement when the movement to lower the shoe 44 and, therefore, also the buckle cover 62 is ended can both be slowed down.

Moreover, in the central portion of the range of movement of the shoe 44, the side surfaces of the shoe 44 are separated respectively from the central portion of the left wall 86 and the central portion of the right wall 88. Accordingly, because the movement resistance of the shoe 44 is comparatively less in these positions, the speed of movement of the shoe 44 and, therefore, also the buckle cover 62 in these positions can be speeded up compared to the speed of movement when the movement to raise up the shoe 44 and the buckle cover 62 is started, and the speed of movement when the movement to lower the shoe 44 and the buckle cover 62 is ended.

Furthermore, on the rear end side of the range of movement of the shoe 44, because the shoe 44 is positioned between the rear end portion of the left wall 86 and the rear end portion of the right wall 88, the side surfaces of the shoe 44 interfere respectively with the left wall 86 and the right wall 88. Accordingly, because the movement resistance of the shoe 44 is comparatively greater in these positions, the speed of movement when the movement to raise up the shoe 44 and, therefore, also the buckle cover 62 is ended, and the speed of movement when the movement to lower the shoe 44 and, therefore, also the buckle cover 62 is started can both be slowed down.

Because the left wall 86 and the right wall 88 are curved, the coming into contact of the shoe 44 with the left wall 86 and the right wall 88, as well as the separation of the shoe 44 from the left wall 86 and the right wall 88 both proceed gradually. In other words, the speed of movement of the buckle cover 62 changes gradually. As a consequence, using a simple structure that does not require any control of the revolution speed of the motor 14, it is possible to slow down the respective speeds of movement when the buckle cover 62 and the buckle 64 both start their movement and end their movement, and thus provide a vehicle occupant with a high-quality buckle cover 62 and buckle 64 operation.

### Fourth Exemplary Embodiment

Next, a lift-up buckle device 99 according to a fourth exemplary embodiment of the present disclosure will be described using FIG. 6. Note that component elements that are basically the same as in the above-described first exemplary embodiment are given the same descriptive symbols and a description thereof is omitted.

As is shown in FIG. 6, a substantially rectangular-plate shaped damper 90 that is serving as an absorption body is disposed on a rear side of the stopping block 16B. This damper 90 is formed, as an example, from rubber, and has elasticity. A movement resistance adjustment portion 100 that protrudes onto the slider 42 and shoe 44 side within the rails 38 is formed integrally with the damper 90. When the slider 42 and the shoe 44 strike the movement resistance adjustment portion 100, the movement resistance adjustment portion 100 absorbs the kinetic energy of the slider 42 and the shoe 44 while undergoing elastic deformation.

Additionally, a damper 94 is disposed as an absorption body in the shaft support hole 52. This damper 94 is formed, as an example, from rubber, and has elasticity. A movement resistance adjustment portion 102 is formed integrally with the damper 94. The movement resistance adjustment portion 102 protrudes onto the slider 42 and shoe 44 side within the rails 38. When the slider 42 and the shoe 44 strike the movement resistance adjustment portion 102, the movement resistance adjustment portion 102 absorbs the kinetic energy of the slider 42 and the shoe 44 while undergoing elastic deformation.

Note that a male screw thread is formed on an outer circumference of the drive screw 26 (see FIG. 2) except for a front end portion and a rear end portion thereof, and the entire male screw thread is formed at the same thread precision.

Here, when the slider 42 and the shoe 44 strike the movement resistance adjustment portions 100 and 102, because the kinetic energy of the slider 42 and the shoe 44 is absorbed so that there is a gradual increase in the movement resistance, the speed of movement of the slider 42 and the shoe 44 can be slowed down. In other words, using a simple structure that does not require any control of the revolution speed of the motor 14, it is possible to slow down the speed of movement when the buckle cover 62 and the buckle 64 end their movement, and thus provide a vehicle occupant with a high-quality buckle cover 62 and buckle 64 operation.

Priority is claimed on Japanese Patent Application No. 2016-167222, filed Aug. 29, 2016, the disclosure of which is incorporated herein by reference.

1. A moving device comprising:
a moving body that is provided in a seatbelt device and is moved;
a movement resistance adjustment portion that is provided on a movement path of the moving body and changes a movement resistance of the moving body; and
a driving component that is screwed together with the moving body and, by rotating, causes the moving body to move in a longitudinal direction, wherein
the movement resistance adjustment portion is provided in the driving component and, in conjunction with the movement of the moving body, changes the movement resistance of the moving body towards the driving component.

2. (canceled)

3. The moving device according to claim 1, further comprising a contacting body along which the moving body is moved relatively,
wherein the movement resistance adjustment portion is provided in the contacting body and changes a state of contact between the moving body and the contacting body in conjunction with the movement of the moving body.

4. The moving device according to claim 3, wherein a protruding portion is provided on the moving body and protrudes onto the contacting body side.

5. The moving device according to claim 1, wherein the movement resistance adjustment portion protrudes onto the movement path side of the moving body, and absorbs kinetic energy from the moving body when struck by the moving body.

6. The moving body according to claim 1, wherein:
the movement resistance adjustment portion is provided on an outer circumference of the driving component;
the movement resistance adjustment portion is formed by a first screw segment that is located on a front side, a second screw segment that is adjacent to a rear side of the first screw segment, and a third screw segment that is adjacent to a rear side of the second screw segment;
male screw threads that each have the same pitch are formed on respective outer circumferences of the first screw segment, the second screw segment, and the third screw segment, and a thread precision of the male screw thread of the first screw segment is lower than a thread precision of the male screw threads of each of the second screw segment and the third screw segment; and
the thread precision of the male screw thread of the second screw segment is higher than the thread precision of the male screw thread of the third screw segment.

7. The moving body according to claim 6, wherein
the thread precision of the male screw threads of the first screw segment, the second screw segment, and the third screw segment is the tolerance of the outer diameter and effective diameter of the screw thread relative to a reference screw thread profile.

8. A moving device comprising:
a moving body that is provided in a seatbelt device and is moved; and
a movement resistance adjustment portion that is provided on a movement path of the moving body and changes a movement resistance of the moving body such that movement resistance is greatest at a movement starting position of the moving body.

9. The moving device according to claim 8, further comprising a contacting body along which the moving body is moved relatively,
wherein the movement resistance adjustment portion is provided in the contacting body and changes a state of contact between the moving body and the contacting body in conjunction with the movement of the moving body.

10. The moving device according to claim 9, wherein a protruding portion is provided on the moving body and protrudes onto the contacting body side.

11. The moving device according to claim 8, wherein the movement resistance adjustment portion protrudes onto the movement path side of the moving body, and absorbs kinetic energy from the moving body when struck by the moving body.

12. The moving body according to claim 8, wherein:
the movement resistance adjustment portion is provided on an outer circumference of the driving component;
the movement resistance adjustment portion is formed by a first screw segment that is located on a front side, a second screw segment that is adjacent to a rear side of the first screw segment, and a third screw segment that is adjacent to a rear side of the second screw segment;
male screw threads that each have the same pitch are formed on respective outer circumferences of the first screw segment, the second screw segment, and the third screw segment, and a thread precision of the male screw thread of the first screw segment is lower than a thread precision of the male screw threads of each of the second screw segment and the third screw segment; and
the thread precision of the male screw thread of the second screw segment is higher than the thread precision of the male screw thread of the third screw segment.

13. The moving body according to claim 12, wherein
the thread precision of the male screw threads of the first screw segment, the second screw segment, and the third screw segment is the tolerance of the outer diameter and effective diameter of the screw thread relative to a reference screw thread profile.
